(19) United States
(12) Patent Application Publication
(10) Pub. No.: US 2008/0055150 A1
(43) Pub. Date: Mar. 6, 2008

(54) METHOD AND SYSTEM FOR DETECTING AND DECODING AIR TRAFFIC CONTROL REPLY SIGNALS

(75) Inventors: Weiguang Hou, Lenexa, KS (US); Edward W. Needham, Wellsville, KS (US)

Correspondence Address: GARMIN INTERNATIONAL, INC.;ATTN: Legal - IP, 1200 EAST 151ST STREET, OLATHE, KS, 66062, US

(73) Assignee: GARMIN INTERNATIONAL, INC., Olathe, KS (US)

(21) Appl. No.: 11/470,532

(22) Filed: Sep. 6, 2006

(51) Int. Cl. G01S 7/527; G01S 13/91

(52) U.S. Cl. 342/40; 342/195; 342/36; 342/197; 342/91

(57) ABSTRACT

A method and system are provided for detecting an edge of a received signal associated with air traffic control communications. The system includes an A/D converter to convert a received signal to a series of digital data samples and an edge detector module to determine a change rate between the data samples. The change rate represents a change in amplitude between the data samples per unit of time. The edge detector module validates an edge of the received signal based on the change rate between the data samples. A decoder module may derive timing information from the leading/trailing edge pulses and associates the reply message with the framing pulse based on the timing information.

### BACKGROUND OF THE INVENTION

Embodiments of the present invention relate generally to the detection and decoding of received signals that represent ATCRBS reply pulses for the Pulse Code Modulation (PCM) signal in Air Traffic Control Radar Beacon System (ATCRBS) and in airborne Traffic Advisory Systems (TAS) and Traffic Alert and Collision Avoidance System (TCAS I or TCAS II).

The ATCRBS system presently in use employs ground based interrogator transmitters to query airborne transponders within the range of operation. An aircraft equipped with an active TCAS system acts as a ground station to interrogate surrounding targets. The system includes an interrogator and transponder to inter-communicate with airborne aircraft. There are several pulse-coding modes in use for interrogation and reply signals. The interrogator transmits a query code to its surrounding air space. The aircraft that receives the query code replies to the interrogation. The interrogator receives the replies and detects a reply code. It also determines the distance between the interrogator and the replying aircraft and the bearing to the replying aircraft. Each interrogator includes a reply receiver, reply decoder, and reply processor which together process received replies of the airborne transponders. The replies contain informational pulses, which may identify the aircraft, convey altitude information, or convey other data depending upon interrogation coding.

A large number of beacon interrogators are in operation in many metropolitan areas. Typically, a large number of aircraft are within the operational range of one or more of these interrogators. Consequently, replies from several aircraft will often be received simultaneously by each interrogator station. Only those replies, which are valid responses to a particular interrogation, are of interest to the respective interrogator station. In conventional decoders other replies, known as False Replies Unsynchronized In Time (FRUIT), cause a major processing problem, which becomes acute in high reply density areas. Further, conventional decoders experience “garbled” replies when two or more replies arrive at the interrogator station at approximately the same time. Detection and degarbling of overlapping valid replies is a substantial problem confronted by reply decoders. Therefore, it is desirable to eliminate problems associated with FRUIT and reply garbling without losing valid replies. Thus, detecting leading/trailing edges correctly is very important in the successful decoding of a message.

The reply formats prescribed for the ATCRBS reply modes include one leading framing pulse (F1) and one trailing framing pulse (F2) separated by 20.3 microseconds. The trailing frame pulse may be followed by a Special Position Identification (SPI) pulse for ATCRBS system. There will be no SPI pulse for the TAS or TCAS systems. Valid reply pulse trains are recognized by the above noted spacing between framing pulses, and informational pulses are synchronized for decoding based upon the timing of the initial framing pulse. This function is accomplished by a bracket checking logic circuit in the reply decoder. In the past, conventional reply decoders and processors have experienced another problem due to the reply format when overlapped or closely spaced replies are present. In particular, replies known as “phantom replies” occur whenever two framing or informational pulses arrive at the reply decoder with the same time separation between them (20.3 microseconds) as two valid framing pulses. It is desirable to identify and discriminate against phantom replies while saving the valid informational pulses, which may have been complicit in formatting of the phantom reply.

Moreover, conventional decoders have experienced additional limitations in connection with pairing framing pulses. In conventional decoders, the leading edges are shifted into a shift register buffer, which can store leading edges detected in the time period of 20.3 microseconds. Hardware logic continuously checks the F1 and F2 framing pulse leading edges. If a valid frame bracket is detected, the frame is detected and the leading edges in the corresponding position are decoded as the message. However, conventional decoders have a potential to identify phantom replies as actual replies. For example, when two replies are received and are spaced apart by a multiple of 1.45 microseconds, conventional decoders incorrectly conclude that a valid framing bracket has been detected and a phantom reply is output. To address the problem of phantom replies, additional control logic has been added to conventional decoders to avoid unexpected phantom outputs. However, the additional control logic increases system complexity and cost.

A need remains for an improved edge detector and reply message decoder that address the above noted problems and other problems experienced heretofore.

### BRIEF DESCRIPTION OF THE INVENTION

In accordance with an embodiment of the present invention, a system is provided for detecting an edge of a received signal associated with air traffic control communications. The system includes an A/D converter to convert a received signal to a series of digital data samples and an edge detector module to determine a change rate between the data samples. The change rate represents a change in amplitude between the data samples per unit of time. The edge detector module validates an edge of the received signal based on the change rate between the data samples.

Optionally, the edge detector module may determine a change rate based on changes in amplitudes of immediately adjacent consecutive data samples and compares the change rate to a first change rate threshold, a second change rate threshold, a third change rate threshold, or a fourth change rate threshold. The edge detector module may determine a change rate based on changes in amplitudes of non-consecutive data samples that are separated from one another by at least one data sample and compare the change rate to a first change rate threshold, a second change rate threshold, a third change rate threshold, or a fourth change rate threshold. The edge detector module may further determine a series of the change rates and validate the edge of the received signal when consecutive multiple change rates satisfy a detection criteria. The system may further comprise a pulse width module for comparing a pulse width of the received signal defined by the data samples with a pulse width criteria, wherein a valid edge output is produced when the edge detector module validates the edge of the received signal and the pulse width module determines that the pulse width of the received signal satisfies the pulse width criteria.

In accordance with another embodiment of the present invention, a method is provided for detecting an edge of a received signal associated with air traffic control communications. The method includes converting a received signal to a series of digital data samples and determining a change rate between the data samples. The change rate represents a change in amplitude between the data samples per unit of time. The method further includes validating an edge of the received signal based on the change rate between the data samples.

In accordance with an alternative embodiment, a system is provided for decoding received signals associated with an air traffic control communication. The system comprises an A/D converter to convert received signals to a series of digital data samples. The data samples define a reply message and framing pulses. The system also includes an edge detector module to detect edges of the reply message and framing pulses and, in response thereto, outputting leading/trailing edge pulses and a decoder module to decode a select reply message. The select reply message includes a reply message and framing pulses. The decoder module derives timing information from the leading/trailing edge pulses and associates the reply message with the leading framing pulse based on the timing information.

Optionally, the decoder module may include timer counters that are initiated upon receipt of a leading edge pulse of a potential leading framing pulse. The decoder module determines whether a potential reply message pulse is an actual reply message pulse based on a time interval between leading edge pulses of a preceding associated framing pulse and a leading edge pulse of the potential reply message. The system may include multiple decoder modules joined in parallel with the edge detector module. The decoder modules are assigned to separate potential reply messages based upon leading edge pulses of the potential reply messages. Optionally, the decoder module may include a confidence determination module to produce confidence information representing a level of confidence that a reply message is valid.

In accordance with an alternative embodiment, a method is provided for decoding received signals associated with an air traffic control communication. The method comprises converting received signals to a series of digital data samples, where the data samples define a reply message and framing pulses; and detecting edges of the reply message and framing pulses and, in response thereto, outputting leading/trailing edge pulses. The method also includes decoding a select reply message. The select reply message includes reply message pulses and framing pulses. The decoding includes deriving timing information from the leading/trailing edge pulses and associating the reply message with the leading framing pulse based on the timing information.

### BRIEF DESCRIPTION OF THE DRAWINGS

FIG. 1 illustrates a block diagram of a reply pulse processor module formed in accordance with an embodiment of the present invention.

FIG. 2 illustrates a block diagram of an edge detector module within the reply pulse processor module of FIG. 1.

FIG. 3 illustrates a flow diagram of a processing sequence carried out to detect leading and trailing edges of a valid reply pulse in accordance with an embodiment of the present invention.

FIG. 4 illustrates a timing diagram of exemplary signals produced within the edge detector module of FIG. 2 when processing non-overlapping reply signals in accordance with an embodiment of the present invention.

FIG. 5 illustrates an exemplary stream of data samples that may be produced from a received signal.

FIG. 6 illustrates a timing diagram of exemplary signals produced within the edge detector module of FIG. 2 when processing overlapping reply signals in accordance with an embodiment of the present invention.

FIG. 7 illustrates a block diagram of a message decoder and output logic formed in accordance with an alternative embodiment of the present invention.

FIG. 8 illustrates a block diagram of a message decoder formed in accordance with an embodiment of the present invention.

FIG. 9 illustrates an exemplary pulse sequence for multiple non-overlapping reply pulses received by the message decoder of FIG. 8.

FIG. 10 illustrates an exemplary pulse sequence for multiple overlapping reply pulses to be received by the message decoder of FIG. 8.

### DETAILED DESCRIPTION OF THE INVENTION

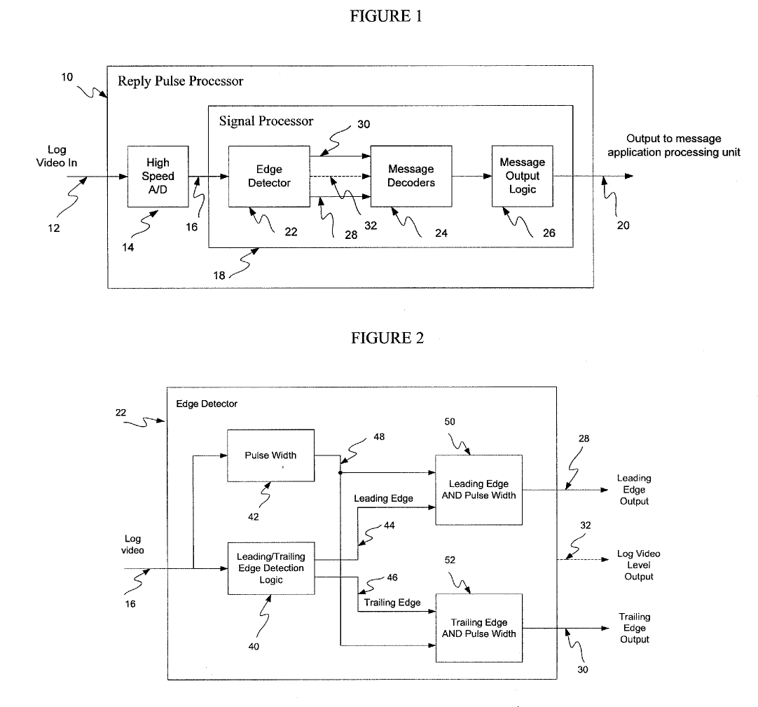

FIG. 1 illustrates a block diagram of a reply pulse processor module 10 that is formed in accordance with an embodiment of the present invention. The reply pulse processor module 10 receives a log received video signal 12 that is digitized by a high speed A/D converter 14 to produce a stream of digitized data samples 16. The data samples 16 represent the received signal associated with air traffic control communications. For example, the received signal may constitute reply pulses for a Pulse Code Modulated (PCM) signal in an Air Traffic Control Radar Beacon System (ATCRBS) or in an airborne Traffic Alert and Collision Avoidance System (TCAS). The data samples 16 are fed to a signal processor module 18 to generate a message data stream 20. The message data stream 20 from the signal processor module 18 is then fed to an application processing unit, which decodes the message data stream 20 to determine another aircraft's identity, bearing, distance, altitude, etc.

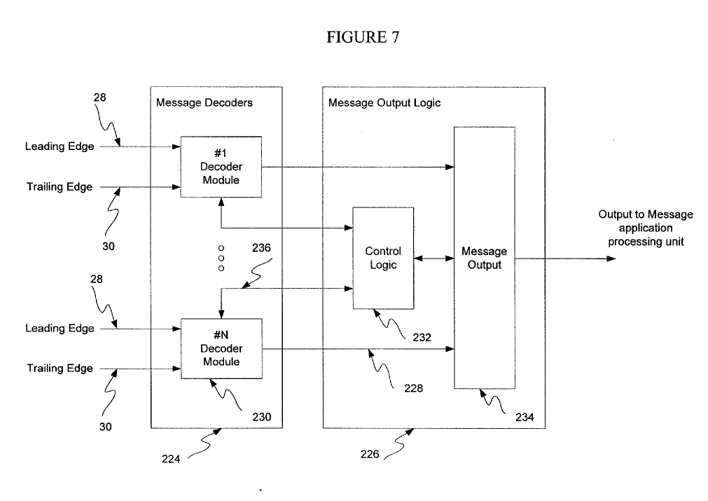

The signal processor module 18 may be implemented on a Field Programmable Gate Array (FPGA). The signal processor module 18 includes an edge detector module 22, a message decoder module 24 and message output logic 26. The message decoder module 24 and message output logic 26 are described below in more detail in connection with FIGS. 7-10. The edge detector module 22 processes the data samples 16 to identify leading edges and trailing edges of valid PCM pulses. The edge detector module 22 identifies and analyzes successive data samples 16 to detect amplitude changes between consecutive and intermittent data samples 16. The edge detector module 22 compares the amplitude changes with different thresholds, when processing the data samples 16, to account for select conditions of the data samples 16, such as when the data samples 16 are associated with reply pulses from overlapped receive signals. The edge detector module 22 generates one or more detection signals, namely a leading edge pulse 28, a trailing edge pulse 30, and optionally a quantized video level signal 32.

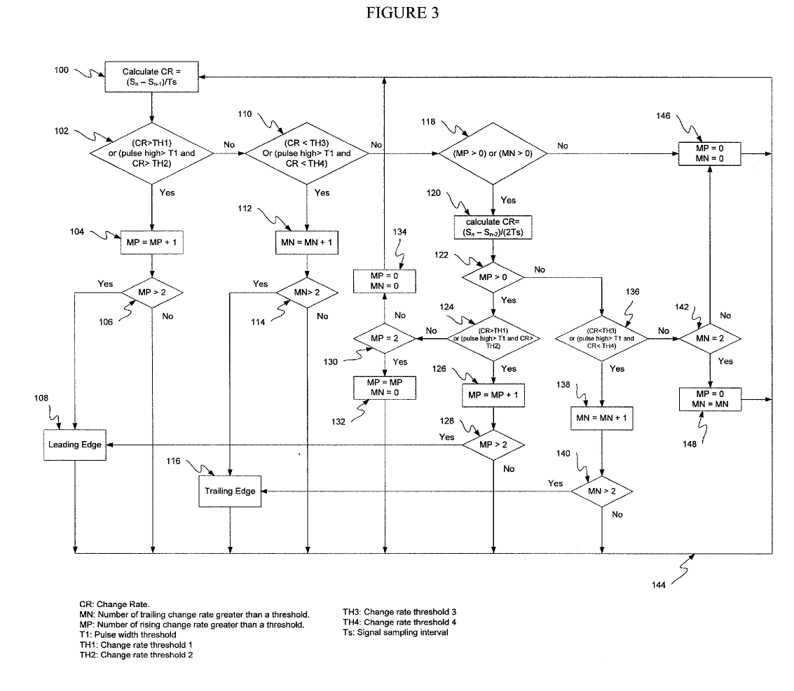

FIG. 2 illustrates a block diagram of the edge detector module 22 within the reply pulse processor module 10 of FIG. 1. The edge detector module 22 receives and directs the data samples 16 to a leading/trailing edge detection logic (EDL) module 40 and to a pulse width module 42. The EDL module 40 determines a change rate between the data samples 16. The change rate represents a change in amplitude between the select data samples 16 per unit of time. The leading/trailing edge detection logic module 40 validates an edge (e.g., leading edge, trailing edge, neither) of the received signal based on the change rate between the data samples 16. The EDL module 40 may determine a series of the change rates and validate the edge of the received signal when consecutive change rates satisfy detection criteria, such as a change rate threshold. The EDL module 40 may determine the change rate(s) based on changes in amplitudes of adjacent consecutive data samples 16 and compares the change rate to a first change rate threshold, a second change rate threshold, a third change rate threshold, or a fourth change rate threshold. The EDL module 40 may also determine the change rate(s) based on changes in amplitudes between non-consecutive data samples, separated from one another by at least one intervening data sample, and compare each change rate to a first change rate threshold, a second change rate threshold, a third change rate threshold, or a fourth change rate threshold. When the EDL module 40 validates a leading edge, the EDL module 40 outputs a valid leading edge signal 44. Similarly, when the EDL module 40 validates a trailing edge, the EDL module 40 outputs a valid trailing edge signal 46.

The pulse width module 42 compares a pulse width of the received signal that is defined by the data samples 16 with a pulse width criteria, such as a pulse width threshold. For example, the pulse width module 42 determines whether the width of the pulse defined by the data samples 16 is wider that the pulse width threshold. When the width of the pulse defined by the data samples 16 satisfies (e.g., equals or exceeds) the pulse width threshold, the pulse width module 42 outputs a valid pulse width signal 48. In this example, pulse width is defined by the interval that the signal level is higher than a threshold.

The edge detector module 22 further preferably includes a leading edge output module 50 and a trailing edge output module 52. The leading edge output module 50 receives, as inputs, the valid leading edge signal 44 and the valid pulse width signal 48. When the valid leading edge signal 44 and the valid pulse width signal 48 are both concurrently “high”, this indicates that a leading edge of the received signal has been validated and that the pulse width of the received signal satisfies the pulse width criteria and therefore, the leading edge module 50 produces a valid leading edge pulse 28. Similarly, the trailing edge output module 52 receives, as inputs, the valid trailing edge signal 46 and the valid pulse width signal 48. When the valid trailing edge signal 46 and the valid pulse width signal 48 are both concurrently “high”, this indicates that a trailing edge of the received signal has been validated and that the pulse width of the received signal satisfies the pulse width criteria and therefore, the trailing edge output module 52 produces a valid trailing edge pulse 30. Optionally the video level signal 32 is recorded and associated with the leading/trailing edge.

FIG. 3 illustrates a flow diagram of the processing sequence carried out by the EDL module 40 to detect leading or trailing edges of a valid reply pulse in accordance with an embodiment of the present invention. As explained above, the edge detection is performed by checking the change rate of the received log video signal amplitude. Whenever, the amplitude change rate meets the detection criteria, a leading or trailing edge is detected. The abbreviations used in FIGS. 3-6 correspond to the following parameters. CR represents a change rate that is defined based on a difference in amplitude between measured data samples over a predefined unit of time. Sₙ represents the n-th data sample S. MP represents a count of the number of potential leading edge change rates that are greater than a predetermined change rate threshold. MN represents a count of the number of potential trailing edge change rates that are less than a predetermined negative change rate threshold. Ts represents an interval between data samples. TH1 represents a first change rate threshold for leading edge. TH2 represents a second change rate threshold for leading edge. TH3 represents a third change rate threshold for trailing edge. TH4 represents a fourth change rate threshold for trailing edge. T1 represents a pulse width threshold.

Beginning at 100 in FIG. 3, a change rate CR is calculated by determining a difference between amplitudes of consecutive data samples Sₙ and Sₙ₋₁, and dividing the amplitude difference by a signal sampling interval Ts. At 102, the EDL module 40 attempts to validate a leading edge. It is determined whether the change rate CR is greater than a first threshold TH1. If not, the EDL module 40 determines whether the change rate CR is greater than a second threshold TH2 and whether the pulse width is greater than a pulse width threshold T1. Flow passes to 104 when either 1) the change rate CR exceeds the first threshold TH1 or 2) the change rate CR exceeds the second threshold TH2 and the pulse width exceeds the pulse width threshold T1. Flow passes to 110 if neither of the conditions in 102 is satisfied. At 104, the counter MP is incremented by 1 to record that another rising change rate that meets the condition in 102 has been identified. At 106, it is determined whether the counter MP exceeds a predetermined count (e.g., 2). When the counter MP exceeds the predetermined count at 106, flow passes to 108 where the EDL module 40 outputs a valid leading edge signal 44 (FIG. 2). If the counter MP does not exceed the predetermined count at 106, flow passes along a return path 144 to 100.

Returning to 102, when flow moves from 102 to 110 the EDL module 40 attempts to validate a trailing edge. It is determined whether the change rate CR is less than the third threshold TH3. If not, the EDL module 40 determines whether the change rate CR is less than the fourth threshold TH4 and whether the pulse width is greater than the pulse width threshold T1. Flow passes to 112 when either 1) the change rate CR is below the third threshold TH3 or 2) the change rate CR is below the fourth threshold TH4 and the pulse width exceeds the pulse width threshold T1. Flow passes to 118 if neither of the conditions in 110 is satisfied. At 112, the counter MN is incremented by 1 to record that another trailing change rate that meets the condition in 110 has been identified. At 114, it is determined whether the counter MN exceeds a predetermined count (e.g., 2). When the counter MN exceeds the predetermined count at 114, flow passes to 116 where the EDL module 40 outputs a valid trailing edge signal 46 (FIG. 2). If the counter MN does not exceed the predetermined count at 114, flow passes along the return path 144 to 100.

Returning to 110, when flow moves to 118, the EDL module 40 determines whether either of the counters MP or MN is greater than zero. If neither of counters MP or MN is greater than zero, flow moves to 146, where both counters are reset to zero and flow passes along the return path 144 to 100. If one of the counters MP or MN is greater than zero, flow moves to 120. At 120, a non-consecutive change rate CR is calculated based on non-consecutive data samples Sₙ and Sₙ₋₂, and the edge detection logic module 40 attempts to validate a leading or trailing edge based on non-consecutive data samples Sₙ and Sₙ₋₂. Optionally, the non-consecutive data samples may be spaced further apart (e.g., have more than one intervening data sample therebetween). Optionally, the change rate CR calculated at 100 and at 120 may be based on more than 2 data samples. Next at 122, it is determined whether the counter MP is greater than zero. If the counter MP is greater than zero, flow moves to 124 where the EDL module 40 determines whether the non-consecutive change rate CR is greater than a first threshold TH1. If not, the EDL module 40 determines whether the non-consecutive change rate CR is greater than a second threshold TH2 and whether the pulse width is greater than a pulse width threshold T1. Flow passes to 126 when either 1) the non-consecutive change rate CR exceeds the first threshold TH1 or 2) the non-consecutive change rate CR exceeds the second threshold TH2 and the pulse width exceeds the pulse width threshold T1. Flow passes to 130 if neither of the conditions in 124 is satisfied. At 126, the counter MP is incremented by 1 to record that another rising change rate that meets the condition in 124 has been identified. At 128, it is determined whether the counter MP exceeds a predetermined count (e.g., 2). If the counter MP exceeds the predetermined count at 128, flow passes to 108 where the EDL module 40 outputs a valid leading edge signal 44 (FIG. 2). If the counter MP does not exceed the predetermined count at 128, flow passes along return path 144 to 100.

Returning to 124, when flow moves to 130, it is determined whether the counter MP equals a predetermined count (e.g., 2) and if so, flow moves to 132 where the counter MP is set to equal itself and the counter MN is reset to zero and flow passes along return path 144 to 100. If the counter MP does not equal the predetermined count at 130, flow moves to 134 where the counters MP and MN are both reset to zero and flow passes along return path 144 to 100.

Returning to 122, if the counter MP is not greater than zero, flow passes to 136, where the EDL module 40 determines whether the non-consecutive change rate CR is less than a third threshold TH3. If not, the EDL module 40 determines whether the change rate CR is less than a fourth threshold TH4 and whether the pulse width is greater than the pulse width threshold T1. Flow passes to 138 when either 1) the non-consecutive change rate CR is below a third threshold TH3 or 2) the non-consecutive change rate CR is below a fourth threshold TH4 and the pulse width exceeds the pulse width threshold T1. Flow passes to 142 if neither of the conditions in 136 is satisfied. At 138, the counter MN is incremented by 1 to record that another trailing change rate that meets the condition in 136 has been identified. At 140, it is determined whether the counter MN exceeds a predetermined count (e.g., 2). If the counter MN exceeds the predetermined count at 140, flow passes to 116 where the EDL module 40 outputs a valid trailing edge signal 44 (FIG. 2). If the counter MN does not exceed the predetermined count at 140, flow passes along return path 144 to 100.

Finally, when flow passes from 136 to 142, it is determined whether the counter MN equals the predetermined count. If the counter MN equals the predetermined count (e.g., 2), the counter MP is reset to zero and the counter MN is set to itself (e.g., unchanged) at 148 and passes along the return path 144 to 100. If the counter MN does not equal the predetermined count at 142, flow moves to 146 where both counters MP and MN are reset to zero and flow passes along the return path 144 to 100. The above logic process is repeated continuously for all data samples 16 to identify potential valid leading and trailing edges of the received signal.

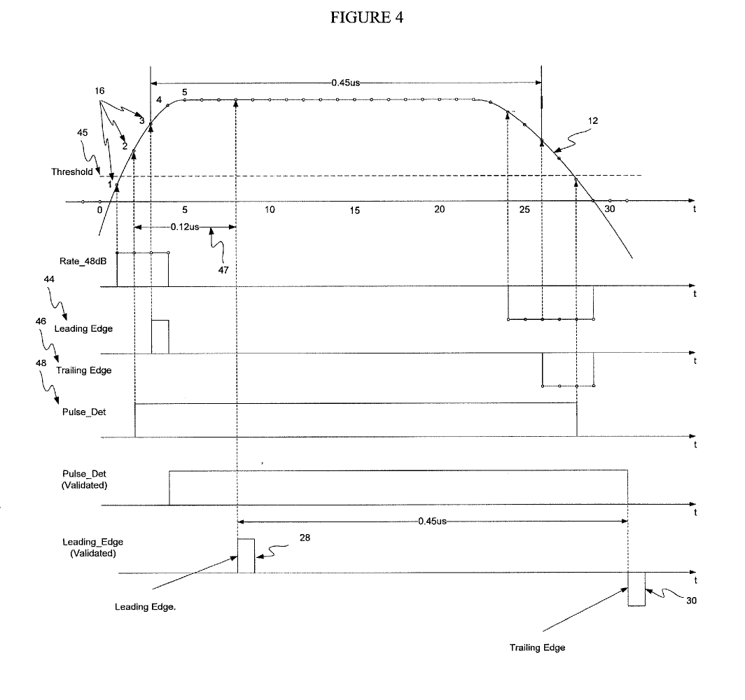

FIG. 4 illustrates a timing diagram of exemplary signals produced within the edge detector module 22 of FIG. 2 when processing non-overlapping reply signals in accordance with an embodiment of the present invention. The received signal 12 is defined by a series of data samples 16. The data samples are denoted at positions 0, 1, 2, 3, 4, etc. and the sample values are denoted as S₀, S₁, S₂, S₃, S₄, etc. The pulse width module 42 (FIG. 2) sets the potential valid pulse width signal 48 to a “high” level upon determining that the second data sample S2 has exceeded the pulse threshold 45. The EDL module 40 sets the potential valid leading edge signal 44 to a “high” level after processing the change rates CR between data samples S₀, S₁, S₂ and S₃.

Once the leading edge output module 50 receives the leading edge signal 44 and the valid pulse width signal 48, the leading edge output module 50 then determines whether the change rate meets the predetermined change rate threshold within a predetermined window 47 following the detection of the leading edge. The window 47 represents a time period in which the leading edge change rate should settle below the CR threshold. Otherwise, the received signal is determined to not include a valid leading edge. In the present example, an air traffic communications specification defines the leading edge change rate criteria to be 48 dB/microsecond and the window to be 0.121 microseconds. With a preferred sampling rate of 50 MHz, the window 47 is set to 0.12 microseconds. At the expiration of the window 47, if the change rate is below the CR threshold, the leading edge output module 50 generates a leading edge pulse 28.

The foregoing process is repeated in search of the trailing edge. The pulse width module 42 (FIG. 2) sets the potential valid pulse width signal 48 to a “high” level upon determining that the second data sample S₂ has exceeded the pulse threshold 45. The edge detection logic module 40 sets the potential valid trailing edge signal 46 to a “high” negative level after processing the change rates CR as described in connection with FIG. 3. Once the trailing edge output module 52 receives the trailing edge signal 46 and the valid pulse width signal 48, a valid trailing edge is declared and a trailing edge pulse 30 is produced. Otherwise, the received signal is determined to not include a valid trailing edge.

Normally the data samples 16 may follow the shape shown in FIG. 4. For example, a model reply signal may exhibit a rising time between 50 ns-100 ns, while the A/D converter 14 may sample with a 50 MHz sampling rate. Thus, there may be 3 to 5 data samples output by the A/D converter 14 (FIG. 1) during each leading edge of a reply pulse and 5 to 7 data samples during each trailing edge of a reply pulse. With each data sample taken, the EDL module 40 performs the processing sequence of FIG. 3. The EDL module 40 calculates the change rate (CR) of the signal amplitude, e.g., CRₙ=(Sₙ−Sₙ₋₁)/Ts; where Ts is the sampling time interval, Sₙ is current sample, Sₙ₋₁ and Sₙ₋₂ are the previous two samples, respectively. The change rates of the signal are CR₁=(S₁−S₀)/Ts, CR₂=(S₂−S₁)/Ts, CR₃=(S₃−S₂)/Ts, CR₄=(S₄−S₃)/Ts, etc. If CRₙ is greater than a defined threshold (denoted as TH1), for example 48 dB/microsecond in the present example, then there is a potential leading edge. Thus, the counter MP=MP+1. If three or more consecutive change rates are greater than the threshold TH1, i.e., MP>2, then a leading edge is detected.

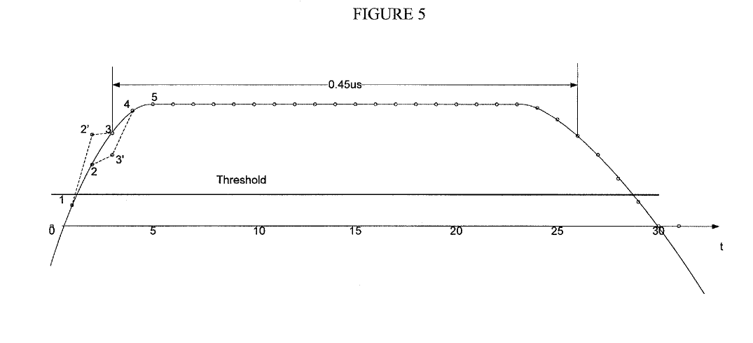

FIG. 5 illustrates an exemplary received signal with non-ideal shape. Due to noise or co-channel interference (such as FRUIT or synchronous replies), the data samples at the leading edge may be distorted and the change rates may not be as expected for the adjacent data samples. However, the overall pulse may still be within the specification of what defines a valid reply signal. Referring to FIG. 5, when the samples are as illustrated as 1, 2′, 3, 4, 5, etc., the EDL module 40 still processes the received signal properly. When the EDL module 40 detects CR₁ (e.g., (S₁−S₀)/Ts) and CR₂ (e.g., (S₂′−S₁)/Ts) greater than TH1 and CR₃=(S₃−S₂′)/Ts is less than TH1, then the EDL module 40 examines CR₃′=(S₃−S₁)/(2Ts) to determine whether CR₃′ is greater than TH1. If CR₃′ is greater than TH1, a leading edge is still detected, although CR₃ is not greater than TH1.

Alternatively, if the samples are as shown in FIG. 5 at 1, 2, 3′, 4, 5, etc. and CR₁ (e.g., (S₁−S₀)/Ts) and CR₂ (e.g., (S₂−S₁)/Ts) are greater than TH1, both CR₃=(S₃′−S₂)/Ts and CR₃′=(S₃′−S₁)/(2Ts) are less than TH1. However, if the counter MP=2, then, the EDL module 40 will wait for the next data sample to check the next change rate. If the next change rate is greater than TH1, then a leading edge will still be detected. These extra steps for checking the data samples eliminate the effect of the imperfect data samples due to noise or interference and hence improve the detection performance.

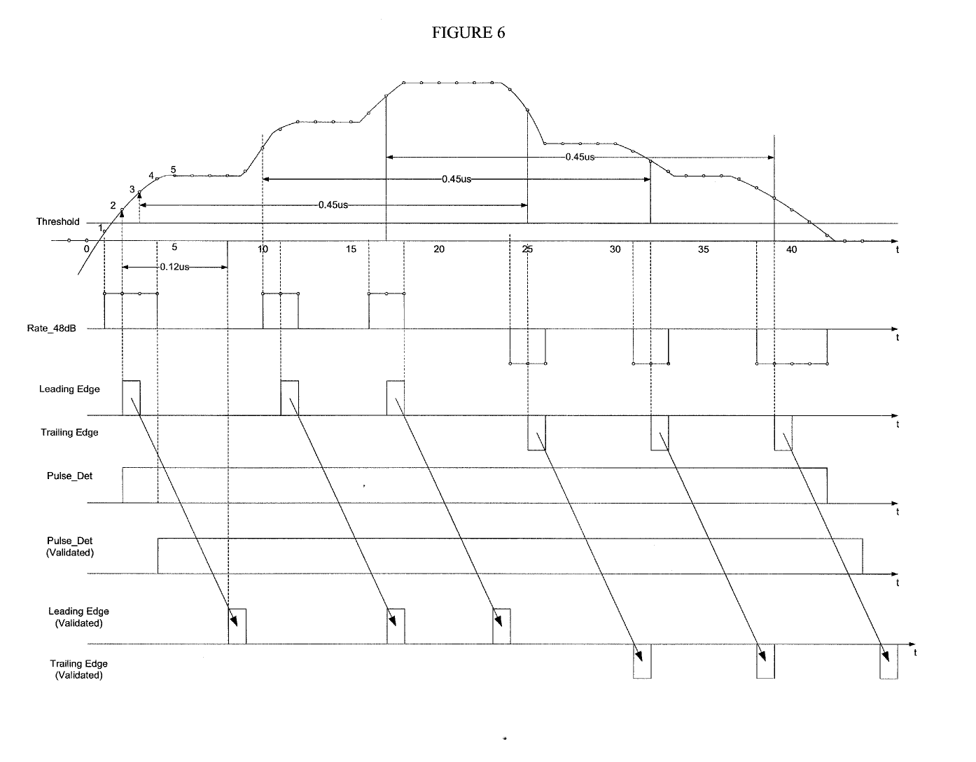

FIG. 6 illustrates a timing diagram of the signals produced within the edge detector module 22 of FIG. 2 when processing overlapping reply signals in accordance with an embodiment of the present invention. When the replying pulses overlap each other, the leading edge change rate may be less than the defined threshold due to signal interference. A lower threshold for the change rate will be desirable. When the signal amplitude has been high for a predetermined time period (T1) and the signal amplitude is changing at a reasonable rate, then there exists a high possibility that the signal is overlapped by one or more pulses. Therefore, a lower threshold is applied. For example, half of the defined change rate, denoted as TH2, 24 dB/microsecond may be chosen in the present example. Optionally, the second threshold TH2 may be adjusted to fit a receiver. In summary, there are two conditions to declare a pulse leading edge, the change rate should be greater than TH1 for three or more intervals Ts, or the pulse amplitude change rate is greater than TH2 and the pulse width is greater than a certain time period.

On the trailing edge, similar detection logic is applied. The standard does not specify the trailing edge change rate in terms of dB/microsecond. Rather, it is stated in terms of fall time as 100 nanoseconds to a maximum of 200 nanoseconds. One could infer that this would be at a rate of 24 dB/microsecond comparing to the leading edge. Thus, the thresholds TH3 and TH4 for the trailing edge detection could be selected as −24 dB/microsecond and −12 dB/microsecond, respectively. The thresholds may be easily modified to be different values when the trailing edge has a different transition time, if necessary.

Specifically, by way of example, if the present invention receives a signal similar to that shown in FIG. 4, then the CR will be greater than TH1 or less than TH3 for a valid leading edge or valid trailing edge, respectively, to be detected using blocks 102 or 110, respectively. Alternatively, if the present invention receives overlapping signals similar to that shown in FIG. 6, then the pulse width will be greater than T1 and the CR will be greater than TH2 or less than TH4 for a valid leading edge or valid trailing edge, respectively, to be detected using blocks 102 or 110, respectively. Finally, if the present invention receives a signal distorted by interference similar to that shown in FIG. 5, the non-consecutive CR of blocks 124 and 136 will be used to detect a valid leading edge or valid trailing edge, respectively.

Optionally, the edge detector module 22 may follow a log video detector and generate three validated signals: (1) leading edge pulse 28; (2) trailing edge pulse 30; and (3) quantized video level signal 32 when the leading/trailing edges are detected. The video level signal 32 corresponding to the leading/trailing edge is optionally output to the decoder as additional information to improve the decoding performance. The leading/trailing edge pulse 28/30 and the optional video level signal 32 are output to the message decoder module 24 for decoding the message.

In the above embodiments, a leading/trailing edge with a narrow pulse width is rejected under the detection logic. The edge detector module 22 (FIG. 1) only outputs leading/trailing edge pulses to the message decoder module 24 with certain pulse widths. The message decoder module 24 decodes the message based on the leading/trailing edge pulse stream. The message decoder module 24 and message output logic 26 then generate a confidence level based on the leading and trailing edges for the message application processing unit as a quality reference to the code decoded. For example, if a leading edge and a trailing edge are detected and the pulse width and timing are within the specification, then this pulse is decoded with high confidence. If only a leading edge or trailing edge is detected and the timing is within the specification, then this pulse is decoded with low confidence.

FIG. 7 illustrates a block diagram of a plurality of message decoders 224 and message output logic 226 that is formed in accordance with an alternative embodiment of the present invention. The message decoders 224 and message output logic 226 may be used in place of the message decoder module 24 and message output logic 26, respectively, of FIG. 1. The message decoders 224 preferably comprise multiple decoder modules 230 that are joined in parallel with one another and commonly controlled by control logic 232 through activation signals 236. Each decoder module 230 receives the same leading edge pulses 28 and same trailing edge pulses 30 (FIG. 2) from the edge detector module 22. The decoder modules 230 perform message decoding by pairing framing pulses based on the leading and trailing edge pulses 28 and 30. Multiple parallel decoder modules 230 are provided to decode an equal number of overlapping reply signals. Each decoder module 230 is assigned a particular potential reply signal to decode. For examples, if ten decoder modules 230 are used, the system would be able to process ten reply signals that overlap. The message output 228 of each decoder module 230 is sent to the message output module 234 to be sent to the message application processing unit. The optional video level signal 32 may be used as an additional condition to make sure all the reply pulses for the select reply message have similar amplitudes.

Initially, the decoder modules 230 are not assigned to any reply signals. When a leading edge pulse 28 is received, the control logic 232 assigns the leading edge pulse 28 to a particular decoder module 230, thereby activating the decoder module 230. As additional leading edge pulses 28 are received that are unrelated (based on predefined allowable pulse spacing) to earlier leading edge pulses, the control logic 232 assigns each leading edge pulse 28 to another decoder module 230 thereby activating additional decoder modules 230. When each new leading edge pulse 28 is received, the activated decoder modules 230 examine the timing to determine if the new leading edge pulse 28 is related to an assigned prior leading edge pulse 28. The timing includes a timer interval between the new leading edge pulse 28 and the previous leading edge pulse 28 assigned to the decoder module 230. Each decoder module 230 tracks an assigned message and outputs a corresponding decoded message to the message output logic 234.

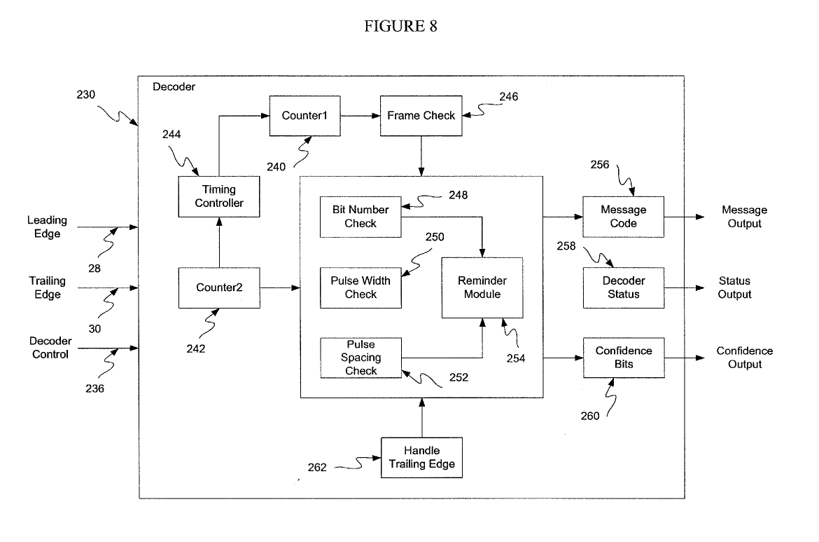

FIG. 8 illustrates a block diagram of one of the decoder modules 230 formed in accordance with an embodiment of the present invention. The decoder module 230 receives the leading and trailing edge pulses 28 and 30, and the activation signal 236 from the control logic 232 (FIG. 7). The decoder module 230 is assigned to a particular select reply message by the control logic 232 (FIG. 7). Once the decoder module 230 is assigned to the unique reply message, the decoder module 230 is only interested in subsequent pulses (e.g., framing and reply message pulses as defined by specific transponder reply protocol) that constitute part of the assigned individual reply message. The decoder module 230 discriminates between reply and framing pulses that are part of the assigned message based on the pulse width and pulse spacing interval. Pulse width is obtained by calculating the interval between pairs of leading and trailing edge pulses 28 and 30, while pulse spacing interval is obtained by calculating the interval between the leading edge pulse of associated leading framing pulse and the leading edge pulses of associated reply message pulses.

The decoder module 230 includes timer counters 240 and 242 that are activated and controlled by a timing controller 244. The timing controller 244 starts the timer counters 240 and 242 when the activation signal 236 is high and the leading edge pulse 28 is received. The timer counters 240 and 242 are utilized by the frame check 246, pulse width check 250, and pulse spacing check 252 to determine whether new pulses are part of the reply message being tracked by the decoder module 230. For example, the timer counter 240 may count for 20.3 microseconds, while the timer counter 242 may count for 0.45 microseconds.

Each time a new leading edge pulse 28 is received, the frame check 246 accesses the timer counter 240 to determine the amount of time that has expired since the leading edge of the initial framing pulse of the assigned reply message. The frame check 246 determines whether the new leading edge pulse 28 has followed a preceding framing pulse by an appropriate time interval associated with the framing pulse spacing. For example, framing pulses may be separated by 20.3 microseconds. Based on this comparison, the frame check 246 seeks to validate subsequent framing pulses.

Each time a new leading edge pulse 28 is received, the pulse spacing check 252 also accesses the timer counter 240 to determine the amount of time that has expired since the leading edge of the initial framing pulse of the assigned reply message. The pulse spacing check 252 determines whether the new leading edge pulse 28 has followed a preceding framing pulse by an appropriate time interval associated with the time between a framing pulse and a reply message pulse. For example, the reply message pulses may appear a spacing interval of N×1.45 microseconds after a framing pulse of a corresponding reply message. Based on this comparison, the pulse spacing check 252 seeks to validate reply message pulses.

Each time a new trailing edge pulse 30 is received, the pulse width check 250 accesses the timer counter 242 to determine the amount of time that has expired since the leading edge of the most recent pulse of the assigned reply message. The pulse width check 250 determines whether the new trailing edge pulse 30 has followed the most recent leading edge pulse 28 by an appropriate time interval associated with the time between leading and trailing edges of a pulse. For example, the leading and trailing edges of a pulse may be separated by an interval of 0.45 microseconds. Based on this comparison, the pulse width check 250 seeks to validate each pulse width.

A bit number check 248 and the pulse spacing check 252 communicate with a reminder module 254. The reminder module 254 processes the outputs of the bit number and pulse spacing checks 248 and 252 to produce a message code 256 and a confidence bit 260 along with leading or trailing edges. A decoder status 258 is set high when the decoder module 230 is active and is set low when the decoder module 230 is inactive. A trailing edge module 262 receives and processes the trailing edge pulses 30.

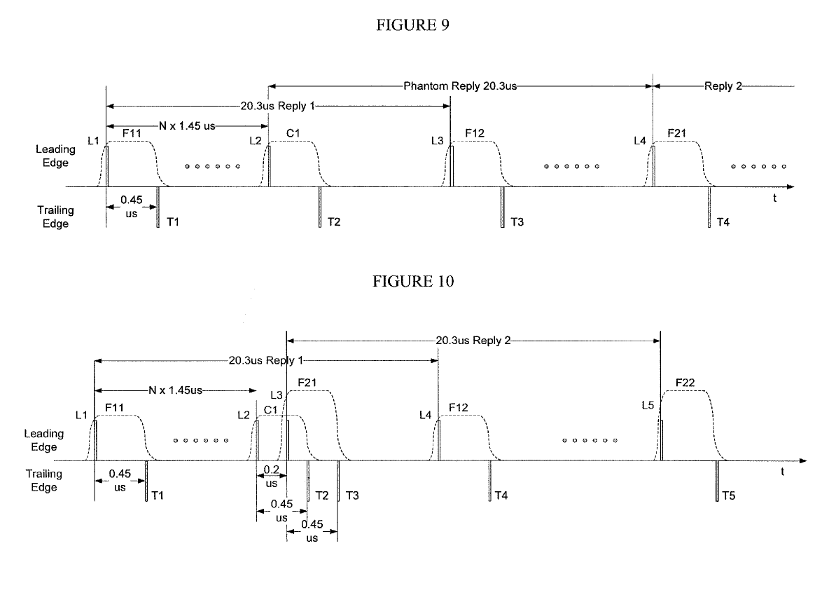

Next, the operation of the decoder module 230 will be explained in connection with FIGS. 9 and 10.

FIG. 9 illustrates an exemplary pulse stream that includes a stream of framing pulses F11, F12 and F21. The pulse stream also includes a reply pulse C1 having a leading edge L2 and a trailing edge T2. In accordance with an air traffic communications specification, the reply pulse C1 is spaced a predetermined time period after the framing pulse F1 (e.g., N×1.45 microseconds, N is an integer ranging from 1 to 13). The framing pulses F11 and F12 correspond to a single reply message. The framing pulses F11 and F12 include leading edges L1 and L3, respectively, separated by a predetermined reply frame time (e.g., 20.3 microseconds). The framing pulse F11 includes the leading edge pulse L1 and a trailing edge pulse T1. The framing pulse F12 includes the leading edge pulse L3 and a trailing edge pulse T3. The leading and trailing edge pulses of a single framing pulse are separated by a predetermined frame pulse width (e.g., 0.45 microseconds). In FIG. 9, the pulse stream also includes an initial framing pulse F21 of a second reply message. The framing pulse F21 includes a leading edge pulse L4 and a trailing edge pulse T4. The framing pulse F21 is coincidentally spaced a time of 20.3 microseconds after the reply pulse C1 and thus the potential exists that the reply pulse C1 and framing pulse F21 may be identified as a phantom frame. As will be explained below in more detail, the decoder modules 230 operate to avoid incorrectly identifying the reply pulse C1 and framing pulse F21 as a phantom reply.

FIG. 10 illustrates an alternative exemplary pulse stream that may be received by the decoder module 230. The pulse stream of FIG. 10 includes framing pulses F1 and F12, associated with a first reply message, that are separated by a predetermined framing time interval. The reply pulse C1 is also shown at the same time as described above, namely N×0.45 (N is an integer ranging from 1 to 13) microseconds after the framing pulse F11. In the example of FIG. 10, a second reply is received overlapping the first reply. The second reply is defined by framing pulses F21 and F22. The first and second reply messages are received with different power levels that are shown by the differences in amplitude of the framing pulses F11, F12 and framing pulses F21, F22. The initial framing pulse F21 of the second reply message is received approximately 0.2 microseconds after the reply pulse C1 of the first reply message.

When the leading edge pulse L1 is received, all of the decoder modules 230 examine the leading edge pulse L1. Initially, it may be assumed that none of the decoder modules 230 are assigned to the leading edge pulse L1. When the first leading edge L1 is received, all of the decoder modules 230 check for the timing of the leading edge L1. Since none of the decoder modules 230 are activated, the L1 leading edge is determined not to belong to any decoder modules 230. Thus, the control logic 232 assigns a decoder module 230 (in this case decoder module #1) to decode the message associated with the leading edge L1. Each new leading edge pulse is similarly analyzed. When a decoder module 230 determines that a new leading edge pulse 28 is within a timing limit of the pulse spacing (e.g., a multiple of 1.45 microseconds), then the new leading edge pulse 28 is determined to belong to the reply pulse for the reply message that the current decoder module 230 has been assigned to decode.

For example, in FIG. 10, at the beginning, no decoder module 230 has been selected to decode the Reply 1. All decoder modules 230 are inactive. When the leading edge pulse L1 is received, the decoder module #1 is assigned to the Reply 1. The timer counters 240 and 242 (FIG. 8) are started. The timer 240 counts over at least a period of time associated with the framing bracket time interval, while the timer 242 counts over at least a period of time associated with the reply pulse width. When trailing edge T1 is received, all of the decoder modules 230 check the timing of corresponding timers 242. When the trailing edge T1 is received within the pulse width limit in decoder module #1, then the trailing edge T1 is paired with the leading edge L1. No other decoder modules 230 will be selected by the control logic 232. When leading edge L2 of the reply pulse C1 is received, all of the decoder modules will again analyze the timing of the leading edge L2. If the leading edge L2 of the reply pulse C1 is determined to be 1.45 microseconds or a multiple of 1.45 microseconds apart from the leading edge L1, then the leading edge L2 is considered to belong to decoder module #1. Still, no other decoder modules 230 will be selected by the control logic 232.

Also, the timing controller 244 adjusts the timer counter 242 of decoder module #1 to equal the modular of 1.45 microseconds. When leading edge L3 is received, all the decoders will check the timing of L3. Assuming that the leading edge L3 is 0.2 microseconds apart from leading edge L2, as shown, leading edge L3 does not belong to any decoder module at this point and thus, the control logic 232 (FIG. 7) assigns decoder module #2 to decode the second reply message that is associates with the leading edge L3. As part of this assignment, a timer counter 240 in decoder module #2 is started to check the framing bracket time interval. Also, a timer counter 242 in decoder module #2 is started to check reply pulse width and period. The same processing procedure is repeated for all the following leading/trailing edges.

When the timer counter 242 passes the time limit for the pulse spacing 1.45 microseconds, this means that no leading/trailing edge was received. Thus, the “a bit” of zero is decoded for this message. At the same time, the frame checks 246 in all of the activated decoder modules continue to actively check the time limits. When the frame timing in counter 240 is up, it is determined whether a leading/trailing edge pair is received within the time limit. In the example of FIG. 10, the leading edge L4 and trailing edge T4 are received and thus, a complete message is decoded. If the frame timing is up and no leading/trailing edge pair is received within the time limit, an invalid frame signal will be generated and sent to the control logic 232. For example, when the frame pulse F12 is not received within the timer limit 20.3 microseconds, the control logic 232 will reset decoder module #1. The decoder modules are reset at the startup of the hardware. After a decoder module 230 has been assigned to decode a message, if there is no valid frame detected, then the decoder module 230 will be reset and labeled as not active and become ready for future use.

Once a message decoding is completed, additional leading/trailing edges with timing of 1.45 microseconds apart from the previous code will not generate a phantom output. Similarly, when the system has not transmitted and a signal is being received, then it is considered as a FRUIT (False Replies Unsynchronized In Time). For replies with Special Position Identification (SPI) pulse, the decoder will ignore the SPI pulse. If SPI pulse needs to be decoded, additional logic is needed. The number of the decoder modules 230 may be varied and there may be as many as desired, depending on the hardware capacity. The decoder modules 230 may be implemented in a Field Programmable Gate Array (FPGA). For example, the system may be configured to decode three to ten or more overlapped signals.

Returning to FIG. 8, when a leading edge and a trailing edge are detected and are separated by a pulse width with the appropriate limit, then the pulse code is labeled with high confidence. If only a leading edge or a trailing edge is detected and the edge timing is within the limit, the pulse code is labeled with low confidence. This information is provided to the message application processing unit as a reference in the tracking of the target. In the preferred implementation, the confidence bit is set to 0 at the start. Once a leading edge is detected, the confidence bit is toggled to 1. When a trailing edge is detected, the confidence bit is toggled again to 0. So the confidence bit with value 0 means high confidence. The confidence bit is set to 1 to indicate low confidence.

Next, the operation of the message output logic 234 in FIG. 7 will be described. The decoded message will be output to the message application processing unit for further processing, e.g., tracking of the target. The decoded message will be output whenever it is ready. The message is combined with other information, e.g., confidence bits, bearing information, time stamp of the message received, and so on to form a package. Because of the length of the information, a Direct Memory Access (DMA) transfer is preferable to minimize the processor interaction. A DMA request will be generated once the message is ready. After the processor responds to the DMA and the information has been transferred to the memory in the processor a reset signal will be generated to reset the corresponding decoder. It is most likely that when a message is being transferred other messages may also be ready for transfer especially when there are overlapped reply pulses that have been received. The message output logic will detect the status and set flags to keep the messages waiting until the current message transmission has completed. The logic will output the messages in the order of being received.

While the invention has been described in terms of various specific embodiments, those skilled in the art will recognize that the invention can be practiced with modification within the spirit and scope of the claims.

What is claimed is:

1. A system for detecting an edge of a received signal associated with air traffic control communications, the system comprising:
an A/D converter to convert a received signal to a series of digital data samples; and
an edge detector module to determine a change rate between the data samples, the edge detector module validating an edge of the received signal based on the change rate between the data samples.

2. The system of claim 1, wherein the edge detector module determines a change rate based on changes in amplitudes of immediately adjacent consecutive data samples and compares the change rate to a change rate threshold.

3. The system of claim 1, wherein the edge detector module determines the change rate based on changes in amplitudes of data samples that are separated from one another by at least one data sample.

4. The system of claim 1, wherein the edge detector module determines a series of the change rates and validates the edge of the received signal when multiple change rates satisfy a detection criteria.

5. The system of claim 1, further comprising a pulse width module for comparing a pulse width of the received signal with a pulse width criteria, wherein a valid edge output is produced when the edge detector module validates the edge of the received signal and the pulse width module determines that the pulse width of the received signal satisfies the pulse width criteria.

6. A method for detecting an edge of a received signal associated with air traffic control communications, the method comprising:
converting a received signal to a series of digital data samples; and
determining a change rate between the data samples;
validating an edge of the received signal based on the change rate between the data samples.

7. The method of claim 6, wherein the determining includes determining a change rate based on changes in amplitudes of immediately adjacent consecutive data samples and compares the change rate to a change rate threshold.

8. The method of claim 6, wherein the determining includes determining the change rate based on changes in amplitudes of data samples that are separated from one another by at least one data sample.

9. The method of claim 6, wherein the determining includes determining a series of the change rates and the validating includes validating the edge of the received signal when multiple consecutive of the change rates satisfy a detection criteria.

10. The method of claim 6, further comprising:
comparing a pulse width of the received signal with a pulse width criteria; and
producing a valid edge output when the edge of the received signal is validated and the pulse width of the received signal satisfies the pulse width criteria.

11. A system for decoding received signals associated with an air traffic control communication, the system comprising:
an A/D converter to convert received signals to a series of digital data samples, the data samples defining reply and framing pulses; and
an edge detector module to detect edges of the reply and framing pulses and, in response thereto, outputting leading edge pulses; and
a decoder deriving timing information from the leading/trailing edge pulses, the decoder associating a reply message with the framing pulses based on the timing information.

12. The system of claim 11, wherein the decoder includes timer counters that are initiated upon receipt of a leading edge pulse of a potential framing pulse, the decoder module determining whether a potential reply message pulse is an actual reply message pulse associated with the potential framing pulse based on a time interval between a leading edge pulses of the potential framing pulse and a leading edge pulse of the potential reply message.

13. The system of claim 11, wherein the decoder includes multiple decoder modules joined in parallel with the edge detector module, each decoder module being assigned to separate overlapping reply messages based upon leading edge pulses of the potential reply messages such that each decoder module tracks reply message pulses and framing pulses within only a single one of the overlapping reply messages.

14. The system of claim 11, wherein the decoder includes a confidence determination module to produce confidence information representing a level of confidence that a reply message is valid.

16. A method for decoding received signals associated with an air traffic control communication, the method comprising:
converting received signals to a series of digital data samples, the data samples defining reply and framing pulses; and
detecting edges of reply messages pulses and framing pulses and, in response thereto, outputting leading/trailing edge pulses; and
deriving timing information from the leading/trailing edge pulses and associating each reply message pulse with an appropriate one of the framing pulse based on the timing information.

17. The method of claim 16, wherein the decoding includes initiating counters upon receipt of a leading edge pulse of a potential framing pulse, and determining whether a potential reply message pulse is an actual reply message pulse associated with the potential framing pulse based on a time interval between a leading edge pulse of the potential framing pulse and a leading edge pulse of the potential reply message.

18. The method of claim 16, further comprising joining multiple decoder modules in parallel, and assigning the decoder modules to separate overlapping reply messages based upon leading edge pulses of the overlapping reply messages such that each decoder module tracks reply message pulses and framing pulses within only a single one of the overlapping reply messages.

19. The method of claim 16, further comprising joining multiple decoder modules in parallel, and activating each of the decoder modules in connection with separate and unique reply messages.

20. The method of claim 16, further comprising producing confidence information representing a level of confidence that a reply message is valid.
